(19) United States
(12) Patent Application Publication
(10) Pub. No.: US 2024/0199841 A1
(43) Pub. Date: Jun. 20, 2024

(54) PROCESS AND SYSTEM FOR RECYCLING EPOXY THERMOSETS

(71) Applicant: ADITYA BIRLA CHEMICALS (THAILAND) LIMITED, BANGKOK (TH)

(72) Inventors: Chandan Kumar Singh, Rayong (TH); Pradip KUMAR Dubey, Mumbai (IN); Szymon Tadeusz Kosinski, Rayong (TH); Satish Kumar Mahanth, Mumbai (IN); Bharat Singh, Mumbai (IN); Pankaj Mathure, Rayong (TH)

(73) Assignee: ADITYA BIRLA CHEMICALS (THAILAND) LIMITED, BANGKOK (TH)

(21) Appl. No.: 18/287,825

(22) PCT Filed: Apr. 22, 2022
(86) PCT No.: PCT/IB2022/053768

§ 371 Date: Oct. 20, 2023

(30) Foreign Application Priority Data
Apr. 23, 2021 (IN) 202021046285

(51) Int. Cl. C08J 11/26; C08J 11/16

(52) U.S. Cl. CPC C08J 11/26; C08J 11/16; C08J 2363/00

(57) ABSTRACT

The present invention relates to a process and system for recycling epoxy thermosets, containing cleavable bonds, said process using an acid solution to dissolve the epoxy thermoset and devolatizing the acid solution from a thermoplastic acidic mixture to produce the thermoplastic component. The process allows recovery of a recyclable thermoplastic component and optionally a recyclable reinforcement matrix component. The process comprising dissolving the epoxy thermoset in an acid solution under heated conditions resulting in a thermoplastic mixture; optionally filtering the thermoplastic mixture to separate out a reinforcement matrix component from a thermoplastic solution; and devolatizing the thermoplastic solution to obtain a recyclable thermoplastic component.

### FIELD OF THE INVENTION

The present invention relates to a process and system for recycling epoxy thermosets containing cleavable bonds, using an acid solution followed by devolatizing the acid solution from a thermoplastic acidic mixture, wherein the process allows recovery and reuse of a recyclable thermoplastic component and optionally a recyclable reinforcement matrix component.

### BACKGROUND OF THE INVENTION

Epoxy resins are an important class of thermosetting compounds. Epoxy resins are economical, have low toxicity and offer a unique combination of thermal, mechanical and chemical resistance properties that are unattainable with other thermoset resins. They have high chemical and solvent resistance, low shrinkage, and excellent adhesion to various substrates. Epoxy resins are also used for manufacturing of fiber-reinforced polymer composites.

Epoxy thermosets have diverse applications and are widely used in automobiles, space & defense equipment, wind mills, structural adhesives, electronics, ceramic manufacturing, microelectronics packaging etc. A wide range of application also exists in civil & construction such as structural components, epoxy cements, floor coating, metal coating, marine coating, paints, decorative art pieces, lacquer etc. Due to superior performance, epoxy resins are also preferred for coating applications such as can coating, powder coating, food & packaging coatings etc.

However, recycling of conventional epoxy resins is difficult as the epoxy resin becomes infusible and insoluble in general-purpose solvents after it is thermo-cured. Particularly, epoxy resins are not melted by heat once they are hardened, and reuse thereof, as a resin material, is difficult. Thus, manufacturing of conventional epoxy resin-cured products and products to which the epoxy resin-cured product adheres or on which the epoxy resin-cured product is applied create large quantities of waste. Also, at the end-of-life cycle it is a challenge to recover and reuse valuable components from the polymeric epoxy matrix and/or recycle epoxy itself. Generally, all the components are disposed and lost through incineration and landfilling. These methods of disposal cause irreversible damage and contamination of the environment.

A class of recyclable epoxies have been developed to allow for depolymerization of epoxy resins wherein the thermoset polymers have cleavable bonds. Recyclable epoxies are prepared using a recyclable acid labile curing agent with a conventional epoxy or a recyclable epoxy resin with a conventional curing agent. The epoxy thermoset polymer formed has cleavable bonds that can permit depolymerization enabling recycling. In case of epoxy composite materials, after depolymerization, the epoxy resins dissolve and other substances such as metal, glass fibre, carbon fibre etc. can be separated, recovered and recycled.

Prior art methods for recycling of recyclable thermoset resins and composites utilize a decomposer such as an acid and solvent. Prior art methods of recycling recyclable thermoset resins utilize an NaOH neutralization step wherein the acid that is used to dissolve the thermoplastic component of the recyclable epoxy thermoset is neutralized using NaOH. This step is not preferred as it generates waste products such as sodium acetate that cannot be disposed as sewage waste, instead requires specialized disposal. The prior art methods are also batch processes that are not industrially relevant and cannot be easily scaled. Thus, there is a need for an industrial, commercially feasible, effective, scalable recycling process where components of the epoxy thermoset and its composites may be recovered with reduced environmental impact.

Accordingly, there remains an opportunity to develop methods for recycling of epoxy polymers and its composites which address one or more problems associated with the methods known in the art, or at least provides a viable alternative to such methods.

### SUMMARY OF THE INVENTION

According to one embodiment the present invention is a process for recycling an epoxy thermoset comprising at least one recyclable component, said process comprising:
i. dissolving the epoxy thermoset in an acid solution under heated conditions of 50 to 110° C. resulting in formation of a thermoplastic mixture;
ii. filtering the thermoplastic mixture to separate out a reinforcement matrix component from a thermoplastic solution; and
iii. devolatizing the thermoplastic solution to remove the acid solution to obtain a recyclable thermoplastic component.

According to another embodiment the present invention is a system for recycling an epoxy thermoset comprising at least one recyclable component, said system comprising:
i. a dissolution subsystem configured to dissolve the epoxy thermoset in an acid solution under heated conditions to form a thermoplastic mixture;
ii. a filtering subsystem configured to filter the thermoplastic mixture to separate out a reinforcement matrix component from a thermoplastic solution; and
iii. a devolatizing subsystem configured to remove the acid solution from the thermoplastic solution to obtain a recyclable thermoplastic component, wherein the devolatizing subsystem comprises an extruder, a falling film evaporator, a distillation unit, or a combination thereof.

According to another embodiment the present invention is a process for recycling an epoxy thermoset comprising a recyclable component, said process comprising:
i. dissolving the epoxy thermoset in an acid solution resulting in at least partial dissolution of the epoxy thermoset to form a thermoplastic mixture; and
ii. devolatizing the thermoplastic mixture to remove the acid solution to obtain a recyclable thermoplastic component comprising a reinforcement matrix component.

According to another embodiment the present invention is a system for recycling an epoxy thermoset comprising a recyclable component, said system comprising:
i. a dissolution subsystem configured to dissolve the epoxy thermoset in an acid solution to form a thermoplastic mixture; and
ii. a devolatizing subsystem configured to remove the acid solution from the thermoplastic mixture to obtain a recyclable thermoplastic component comprising a reinforcement matrix component wherein the devolatizing subsystem comprises an extruder, a falling film evaporator, a distillation unit, or a combination thereof.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows an embodiment of the present process of recycling an epoxy thermoset wherein the epoxy thermoset is dissolved fully (Dissolving Process).

FIG. 2 shows an embodiment of the present process of recycling an epoxy thermoset wherein the epoxy thermoset is at least partially dissolved (Non-Dissolving Process).

FIG. 3 shows an embodiment of the present system of recycling an epoxy thermoset wherein the epoxy thermoset is dissolved fully (Dissolving Process Apparatus).

FIG. 4 shows an embodiment of the present system of recycling an epoxy thermoset wherein the epoxy thermoset is at least partially dissolved (Non-Dissolving Process Apparatus).

FIG. 5a shows graphical data on effect of different concentrations of an acid over time on recycling of epoxy waste at 60° C.

FIG. 5b shows graphical data on effect of different concentrations of an acid over time on recycling of epoxy waste at 80° C.

FIG. 5c shows graphical data on effect of different concentrations of an acid over time on recycling of epoxy waste at 100° C.

### DETAILED DESCRIPTION OF THE INVENTION

In the following detailed description, the embodiments are described in sufficient detail to enable those skilled in the art to practice the invention and it is understood that other embodiments may be utilized and that changes may be made without departing from the scope of the invention. To avoid detail not necessary to enable those skilled in the art to practice the embodiments described herein, the description may omit certain information known to those skilled in the art. Accordingly, the description and figures are to be regarded in an illustrative rather than a restrictive sense, and all such modifications are intended to be included within the scope of the present teachings. It is to be understood that the singular forms “a,” “an,” and “the” include plural referents unless the context clearly dictates otherwise. It should be emphasized that the term “comprises/comprising” when used in this specification is taken to specify the presence of stated features, integers, steps or components but does not preclude the presence or addition of one or more other features, integers, steps, components or groups thereof.

The instant invention intends to address the afore stated prior art disadvantages by providing in one embodiment a process for recycling an epoxy thermoset comprising at least one recyclable component, said process comprising:
dissolving the epoxy thermoset in an acid solution under heated conditions of 50 to 110° C. resulting in formation of a thermoplastic mixture;
filtering the thermoplastic mixture to separate out a reinforcement matrix component from a thermoplastic solution; and
devolatizing the thermoplastic solution to remove the acid solution to obtain a recyclable thermoplastic component.

The process is an industrial dissolving process wherein dissolution of the epoxy thermoset results in formation of a thermoplastic mixture. In a preferred embodiment the process is performed at 100° C. In a preferred embodiment the epoxy thermoset is reduced in size prior to dissolving in the acid solution. Dissolution of thermoplastic in acid solution is total, the resulting thermoplastic mixture comprises undissolved components such as reinforcement matrix components and non-recyclable components suspended in the thermoplastic solution. Filtering removes the undissolved components out of the thermoplastic solution. The thermoplastic dissolved in the acid solution is recovered after removing the acid by devolatizing the acid solution using distillation, wiped film evaporation, and/or devolatizing extruders. The recyclable thermoplastic component obtained using said process may be compounded or reactive extruded for manufacturing of various grades of usable thermoplastics.

In one embodiment of the instant process the filtering further comprises sorting of the undissolved components by centrifugation, manual sorting, optical sorting, or a combination thereof. The undissolved components may be sorted out for recovery and reuse or discarded. The reinforcement matrix components that are removed and recycled separately are almost as good as new materials. This allows for re-capture of almost the full or partial value of reinforcements. In one embodiment of the process the reinforcement matrix component comprises glass fiber, carbon fiber, aramid fiber, jute, grass, bamboo, pine, balsa, any other natural fiber, and a combination thereof and is recyclable.

In one embodiment of the dissolving process the acid solution is acetic acid, lactic acid, propionic acid, any other aliphatic acid, any other organic acid, or a combination thereof, the acetic acid being in a concentration of 5 to 70% and lactic acid being in a concentration of 20 to 80%. According to a preferred embodiment the acid solution is 10 to 15% acetic acid or 50% lactic acid. The recycling process is mild and preferably uses a weak acid. In one embodiment of the instant process the acid solution contains a solvent selected from water, butanol, isopropanol, propanol, ethanol, methanol, benzyl alcohol, ethylene glycol, dichloromethane, tetrahydrofuran, ethyl acetate, acetone, dimethylformamide, acetonitrile, dimethyl sulfoxide, nitromethane, propylene carbonate, pentane, hexane, cyclohexane, benzene, toluene, xylene, dioxanes, glyme, polyethers, diethylether, any other nonpolar solvent, any other polar aprotic solvent, any other polar protic solvent, and a combination thereof.

All devolatized solvent containing acids can be recycled. In one embodiment of the instant process the removed acid solution, the solvent, or both is recycled back in the process. In one embodiment the process is continuous or batch. In a preferred embodiment the process is continuous.

In one embodiment of the process the epoxy thermoset is prepared from a diepoxy resin and a recyclable acid labile curing agent, wherein the recyclable acid labile curing agent is an amine-based hardener, a thiol-based hardener, a poly amino compound, any other acid labile hardener, or a combination thereof.

In one embodiment the recyclable acid labile curing agent is a compound of formula 1 as below:

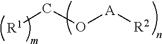

wherein: m is 2, 1, or 0; n is 2, 3, or 4; the sum of m and n is 4;
each R1 is independently hydrogen, alkyl, cycloalkyl, heterocycle, heterocycloalkyl, alkenyl, cycloalkenyl, aryl, heteroaryl, alkyloxyalkyl, or alkynyl;
each A is independently unsubstituted ethylene, propylene, isopropylene, butylene, iso-butylene, hexylene, ethylene-oxy-ethylene, ethylene-amino-ethylene,

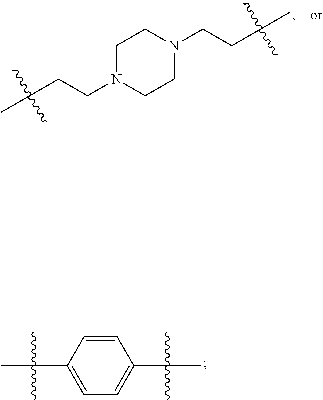 [SMILES: *CCN1CCN(CC*)CC1 ; *c1ccc(*)cc1]

each R2 is independently —NHR3, wherein each R3 is independently hydrogen, alkyl, aminoalkyl, alkylaminoalkyl, cycloalkyl, heterocycle, alkenyl, aryl, or heteroaryl; or, every two —O-A-R2 groups, together with the carbon atom to which they are attached to, can independently form an dioxanyl ring with no less than 4 ring members and one or more of the ring carbon atom(s), other than the carbon atom to which the two —O-A-R2 groups are attached, are independently substituted with one or more independent amino group or aminoalkyl wherein each amino is independently a primary or secondary amino group. In one embodiment the recyclable acid labile curing agent is a compound of formula 2 as below:

(R⁵)ₜ—Si [symbol] O—W—NH₂)_{q}

wherein: q is 4, 3, 2, or 1; t is 0, 1, 2, or 3; the sum of q and t is 4;
each occurrence of W is independently alkylene, cycloalkylene, heterocyclylene, alkenylene, alkynylene, cycloalkenylene, arylene, or heteroarylene; and each occurrence of R⁵ is independently hydrogen, alkyl, cycloalkyl, heterocyclyl, alkenyl, alkynyl, cycloalkenyl, aryl, heteroaryl, amino alkyl, amino aryl, substituted amino group or —OR^{C}, wherein R^{C} is alkyl (e.g., methyl, ethyl), cycloalkyl, heterocyclyl, alkenyl, alkynyl, cycloalkenyl, aryl (e.g., phenyl), or heteroaryl.

In one embodiment the recyclable acid labile curing agents of formula 1, 2, or a combination thereof is used with the diepoxy resin being a conventional diepoxy resin selected from group comprising BPA-diglycidyl ethers, BPF diglycidyl ethers, BPS diglycidyl ethers, reactive diluents, diglycidyl amines, water borne epoxy resins, formulated epoxy resins, and a combination thereof.

In one embodiment of the process the epoxy thermoset is prepared from a recyclable epoxy resin and a curing agent, wherein the recyclable epoxy resin comprises an acid degradable acetal, ketal, orthocarbonate, orthoester, orthosilicate or silane linkage.

In one embodiment the recyclable epoxy resin is a compound of formula 3 or formula 4 as below:

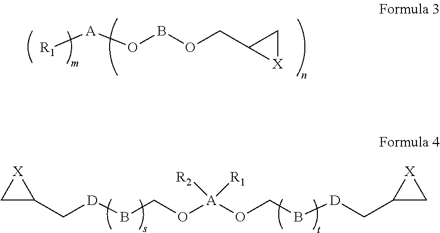

Wherein: m=0 then n=4, m=1 then n=3, m=2 then n=2, A is carbon or silicon, D is oxygen or nitrogen or carboxylic group, X is oxygen or sulfur, s and t is independently from 1 to 20, R1 and R2 is independently hydrogen, alkyl, alkenyl, alkynyl, cycloalkyl, cycloalkenyl, cycloalkynyl, aryl, heterocyclic, heterocycloalkyl, cycloalkenyl, heteroaryl, alkoxyaryl, alkoxy alkyl, B is independently arylene, arylene ethers, alkylene-arylene, alkylene-arylene alkylene, alkenylene-arylene, alkenylene-arylene alkenylene, alkylene-arylene-alkenylene, alkynylene arylene, alkynylene-arylene-alkynylene, heteroarylene, alkylene-heteroarylene, alkylene-heteroarylene-alkylene, alkenylene-heteroarylene, alkenylene-heteroarylene-alkenylene, alkylene-heteroarylene-alkenylene, alkynylene heteroarylene, alkynylene-heteroarylene-alkynylene, alkylene, alkylene-hetero-alkylene, alkenylene, alkenylene-hetero-alkenylene, alkylene-hetero-alkenylene, alkynylene, cycloalkylene, alkylene-cycloalkylene, alkylene-cycloalkylene alkylene, alkenylene-cycloalkylene, alkenylene cycloalkylene-alkenylene, alkylene-cycloalkylene alkenylene, alkynylene-cycloalkylene, alkynylene cycloalkylene-alkynylene, heterocycloalkylene, alkylene heterocycloalkylene, alkylene heterocycloalkylene alkylene, alkenylene heterocycloalkylene, alkenylene heterocycloalkylene-alkenylene, alkylene heterocycloalkylene-alkenylene, alkynylene heterocycloalkylene, alkynylene-heterocycloalkylene alkynylene, cycloalkenylene, alkylene-cycloalkenylene, alkylene-cycloalkenylene-alkylene, alkenylene-cycloalkenylene, alkenylene-cycloalkenylene-alkenylene, alkylene cycloalkenylene-alkenylene, alkynylene-cycloalkenylene, alkynylene-cycloalkenylene-alkynylene, heterocycloalkenylene, alkylene-heterocycloalkenylene, alkylene-hetero cycloalkenylene-alkylene, alkenylene-heterocycloalkenylene, alkenylene-heterocycloalkenylene-alkenylene, alkylene-heterocycloalkenylene-alkenylene, alkynylene heterocycloalkenylene, alkynylene-heterocycloalkenylene, alkynylene.

In one embodiment a recyclable epoxy resin component of formula 3, 4, or a combination thereof is used with a conventional curing agent selected from a group comprising of aliphatic amines, alicyclic polyamines, aromatic amines, polyether amine, ketoimines, anhydrides, polyamides, imidazoles, polythiols, polyphenols, polycorboxylic acid, carboxylic based polyesters, carboxylic based polyacrylates, UV curing agents, water borne curing agents, and a combination thereof.

In one embodiment of the dissolving process the epoxy thermoset is size reduced prior to dissolving in acid solution. The size reduction is achieved using a shredder, milling unit, grinder, blender, crusher, or a combination thereof.

In one embodiment the invention is a recyclable thermoplastic component obtained using the dissolving process as claimed and disclosed hereinabove.

According to another embodiment the present invention is a system for recycling an epoxy thermoset comprising at least one recyclable component, said system comprising:
a dissolution subsystem configured to dissolve the epoxy thermoset in an acid solution under heated conditions to form a thermoplastic mixture;
a filtering subsystem configured to filter the thermoplastic mixture to separate out a reinforcement matrix component from a thermoplastic solution; and
a devolatizing subsystem configured to remove the acid solution from the thermoplastic solution to obtain a recyclable thermoplastic component, wherein the devolatizing subsystem comprises an extruder, a falling film evaporator, a distillation unit, or a combination thereof.

In one embodiment of the system the devolatizing subsystem is configured to remove a solvent from the thermoplastic solution. In one embodiment the system is configured to recycle the removed acid solution, the solvent, or both back in to the process. In one embodiment the system is configured to be continuous or batch. In a preferred embodiment the system is continuous.

According to another embodiment the present invention is a process for recycling an epoxy thermoset comprising a recyclable component, said process comprising:
dissolving the epoxy thermoset in an acid solution resulting in at least partial dissolution of the epoxy thermoset to form a thermoplastic mixture; and
devolatizing the thermoplastic mixture to remove the acid solution to obtain a recyclable thermoplastic component comprising a reinforcement matrix component.
   The process is an industrial non-dissolving process wherein partial dissolution of the epoxy thermoset occurs in the acid solution resulting in formation of a thermoplastic mixture. The non-dissolving process does not filter the reinforcement matrix components out of the thermoplastic solution but the acid is removed by devolatizing. Thus, reinforced recyclable thermoplastic component is generated that can be recycled/reused as other products. The recyclable thermoplastic component generated using said process can be compounded or reactive extruded for manufacturing of various grades of usable thermoplastics.

In one embodiment of the non-dissolving process the epoxy thermoset is reduced in size prior to dissolving in the acid solution. The size reduction is achieved using a shredder, milling unit, grinder, blender, crusher, or a combination thereof. In one embodiment of the non-dissolving process soaking of the epoxy thermoset in the acid solution is performed in heated conditions from 50° C. to 110° C. In one embodiment the process is performed at 100° C.

In one embodiment of the non-dissolving process the acid solution is acetic acid, lactic acid, propionic acid, any other aliphatic acid, any other organic acid, sulfuric acid, phosphoric acid, any other inorganic acid, or a combination thereof, the acetic acid being in a concentration of 5 to 70%, lactic acid being in a concentration of 20 to 80%, sulfuric acid being in a concentration of 1 to 10%, phosphoric acid being in a concentration of 20 to 90%. According to a preferred embodiment the acid solution is 10 to 15% acetic acid, 50% lactic acid or 85% phosphoric acid. In one embodiment of the non-dissolving process the acid solution contains a solvent selected from water, butanol, isopropanol, propanol, ethanol, methanol, benzyl alcohol, ethylene glycol, dichloromethane, tetrahydrofuran, ethyl acetate, acetone, dimethylformamide, acetonitrile, dimethyl sulfoxide, nitromethane, propylene carbonate, pentane, hexane, cyclohexane, benzene, toluene, xylene, dioxanes, glyme, polyethers, diethylether, any other nonpolar solvent, any other polar aprotic solvent, any other polar protic solvent, and a combination thereof.

In one embodiment of the non-dissolving process the removed acid solution, the solvent, or both is recycled back in the process.

In one embodiment of the non-dissolving process the epoxy thermoset is prepared from: a diepoxy resin and a recyclable acid labile curing agent, wherein the recyclable acid labile curing agent is an amine-based hardener, a thiol-based hardener, a poly amino compound, any other acid labile hardener, or a combination thereof; or

a recyclable epoxy resin and a curing agent, wherein the recyclable epoxy resin comprises an acid degradable acetal, ketal, orthocarbonate, orthoester, orthosilicate or silane linkage. In one embodiment the recyclable acid labile curing agent is of formula 1, 2, or a combination thereof. In one embodiment the recyclable epoxy resin component is of formula 3, 4, or a combination thereof

In one embodiment of the non-dissolving process the reinforcement matrix component comprises glass fiber, carbon fiber, aramid fiber, jute, grass, bamboo, pine, balsa, any other natural fiber, and a combination thereof.

In one embodiment the invention is a recyclable thermoplastic component obtained using the non-dissolving process as claimed and disclosed herein.

According to another embodiment the present invention is a system for recycling an epoxy thermoset comprising a recyclable component, said system comprising:
a dissolution subsystem configured to dissolve the epoxy thermoset in an acid solution to form a thermoplastic mixture; and
a devolatizing subsystem configured to remove the acid solution from the thermoplastic mixture to obtain a recyclable thermoplastic component comprising a reinforcement matrix component wherein the devolatizing subsystem comprises an extruder, a falling film evaporator, a distillation unit, or a combination thereof.

In one embodiment of the system the devolatizing subsystem is configured to remove a solvent from the thermoplastic solution. In one embodiment the system is configured to be continuous or batch. In a preferred embodiment the system is continuous. In one embodiment the system is configured to recycle the removed acid solution, the solvent, or both back in to the process.

The epoxy thermoset dissolved using the instant processes include but is not limited to an epoxy thermoset, epoxy thermoset composite, or epoxy thermoset from manufacturing waste. Composites include reinforcement matrix and optionally non-recyclable components. The epoxy thermosets may also consist of additives such as pigments, flexibilizers, tougheners, surface modifiers, fillers, foaming agents, curing catalysts, accelerators, and a combination thereof.

In the processes disclosed herein no neutralization step is required, as the acid solution (e.g. acetic acid) and/or solvent from the thermoplastic solution or thermoplastic mixture is evaporated in a devolatizing subsystem. Devolatizing the thermoplastic solution or thermoplastic mixture removes the acid solution to obtain a recyclable thermoplastic component.

Previously described recycling methods use neutralization of the acid (eg. acetic acid) in the thermoplastic solution/thermoplastic mixture, neutralization being technically easier than devolatizing. The instant method comprises passing the filtered thermoset solution or thermoplastic mixture through a devolatizing extruder to remove any excess solvent and/or acid (catalyst) without the need for neutralization. Thus, the instant process reduces environmental impact as sodium acetate, a by-product of the prior art neutralization protocol, is not generated. The cost of the process is also reduced due to the reduction in unit processes. Further, the devolatized acid solution, solvent or both can be recycled back into the process, further adding to the economic advantage of instant processes.

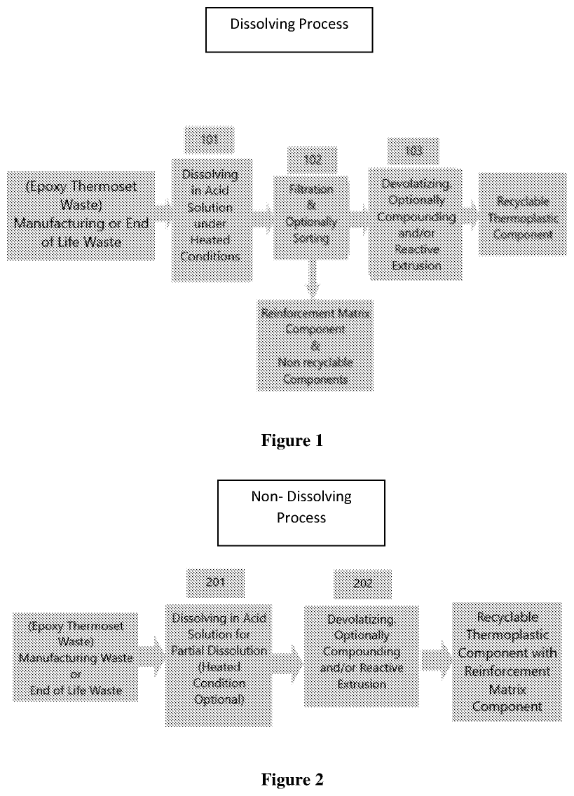

FIG. 1 shows an embodiment of the present process of recycling an epoxy thermoset wherein the epoxy thermoset is dissolved fully. The dissolving process embodiment of FIG. 1 involves recycling an epoxy thermoset comprising at least one recyclable component comprising soaking the epoxy thermoset in an acid solution under heated conditions of 50 to 110° C. resulting in dissolution of the epoxy thermoset to form a thermoplastic mixture (101). In one embodiment, prior to dissolution in the acid solution, the epoxy thermoset may be reduced to smaller pieces as it permits more effective cleavage thus quicker dissolution. Next, filtering the acidic thermoplastic mixture to separate out a reinforcement matrix component and optionally a non-recyclable component from a thermoplastic solution (102). Devolatizing the thermoplastic solution to remove the acid solution to obtain a recyclable thermoplastic component (103). The recyclable thermoplastic component obtained using said process may be compounded or reactive extruded for manufacturing of various grades of usable thermoplastics. One of the advantages of the instant process is that the acid solution from the acidic thermoplastic solution can simply be evaporated without the need to neutralize with caustic. This allows for reuse of the acid and no waste is generated. During testing the dissolving process allowed for complete recovery of carbon fiber cloth (reinforcement matrix component) in close to virgin state.

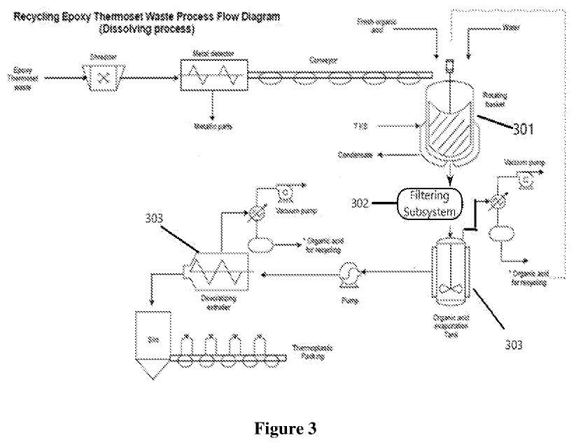

FIG. 2 shows an embodiment of the present process of recycling an epoxy thermoset wherein the epoxy thermoset is at least partially dissolved. The non-dissolving process involves recycling an epoxy thermoset comprising a recyclable component by soaking the epoxy thermoset in an acid solution resulting in at least partial dissolution of the epoxy thermoset to form a thermoplastic mixture (201). In one embodiment, prior to dissolution in the acid solution, the epoxy thermoset may be reduced to smaller pieces as it permits more effective cleavage thus quicker dissolution. Next, devolatizing the acidic thermoplastic mixture to remove the acid solution to obtain a recyclable thermoplastic component comprising a reinforcement matrix component (202). The recyclable thermoplastic component obtained using said process may be compounded or reactive extruded for manufacturing of various grades of usable thermoplastics. In the non-dissolving process fibers cannot be recovered, which may be a preferred option if fibers are inexpensive (e.g. glass fibers). One of the advantages of the instant process is that the acid solution from the acidic thermoplastic solution can simply be evaporated without the need to neutralize with caustic. This allows for reuse of the acid and no waste is generated.

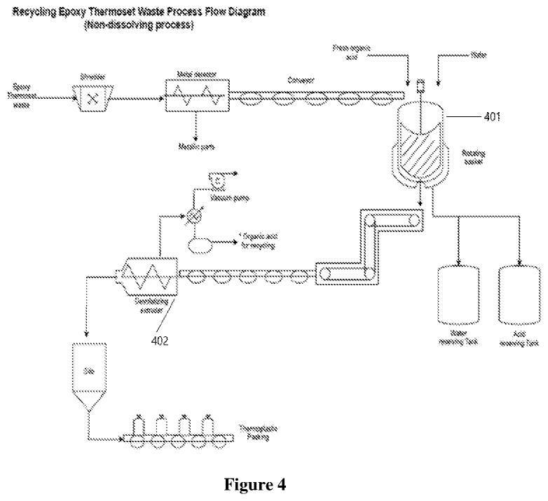

FIG. 3 shows an embodiment of the present system of recycling an epoxy thermoset wherein the epoxy thermoset is dissolved fully (Dissolving Process Apparatus). The apparatus in this embodiment comprises the epoxy waste being passed through a shredder followed by removal of metallic parts using a metal detector. The remaining epoxy waste is passed into a dissolution subsystem (301) configured to dissolve the epoxy thermoset in an acid solution under heated conditions to form a thermoplastic mixture. The acidic thermoplastic mixture is passed through a filtering subsystem (302) configured to filter the thermoplastic mixture to separate out a reinforcement matrix component and an optional non-recyclable component from a thermoplastic solution. The thermoplastic solution is then passed through a devolatizing subsystem (303) configured to remove the acid solution from the thermoplastic solution to obtain a recyclable thermoplastic component. The devolatizing subsystem may comprise an extruder, a falling film evaporator such as the organic acid evaporation tank used in this embodiment, a distillation unit, or a combination thereof. The organic acid (and solvent if used) is recycled back into the process making the process technically and economically advantageous. The apparatus is preferably continuous. The apparatus was created wherein the epoxy waste was soaked in acetic acid solution of varying concentrations between 5 to 50% for 1-3 days at varying temperatures between 20 to 100° C., this resulted in conversion of epoxy to thermoplastics. Other acids that were tested and shown to be effective were lactic acid and propionic acid. Recycling at high temperatures such as 100° C. required designing a container that was closed and capable of handling the pressure generated due to boiling (high pressure rating recycling equipment was needed). The apparatus reduced the inconvenient smell generated and reduced solution loss due to rapid evaporation at the higher temperatures.

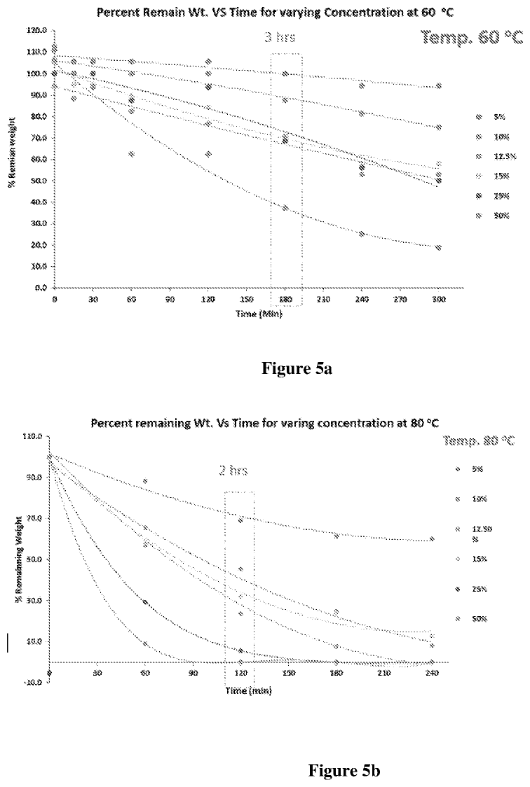

FIG. 4 shows an embodiment of the present system of recycling an epoxy thermoset wherein the epoxy thermoset is at least partially dissolved (Non-Dissolving Process Apparatus). The apparatus in this embodiment comprises the epoxy waste being passed through a shredder followed by removal of metallic parts using a metal detector. The remaining epoxy waste is passed into a dissolution subsystem (401) configured to partially dissolve the epoxy thermoset in an acid solution to form a thermoplastic mixture; and a devolatizing subsystem (402) configured to remove the acid solution from the acidic thermoplastic mixture to obtain a recyclable thermoplastic component comprising reinforcement matrix component. The devolatizing subsystem may comprise an extruder as shown in this embodiment, a falling film evaporator, a distillation unit, or a combination thereof.

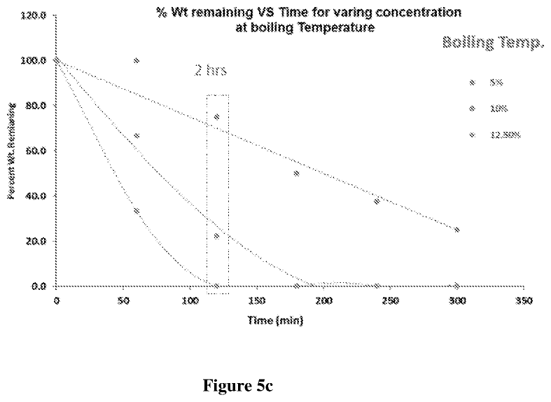

FIG. 5a shows graphical data on effect of different concentrations of acetic acid over time on recycling of epoxy waste at 60° C. FIG. 5b shows graphical data on effect of different concentrations of acetic acid over time on recycling of epoxy waste at 80° C. FIG. 5c shows graphical data on effect of different concentrations of acetic acid over time on recycling of epoxy waste at 100° C. Higher concentration of acetic acid gives faster recycling at 60° C., 80° C. and 100° C. At boiling temperature (100° C.) there is a dramatic effect on speed of recycling. 12.5% acetic acid at boiling temperature (100° C.) results in complete recycling in 2 hours. At higher concentrations of acetic acid increasing the temperature reduces time of recycling, 50% acetic acid takes about 8 hours at 60° C. (not shown) but only 2 hours at 80° C. (FIG. 5b) to complete recycling. Speed of any chemical process increases with temperature increasing. However, for low concentrations of acetic acid, recycling is very slow (e.g. 10% acetic acid at 60° C. results in only 20% mass recycled in 6 hours) or not at all (e.g. 5% acetic acid does not proceed in 3 hours) but recycling surprisingly completes in just 3 hours at 100° C. in 10% acetic acid and half completes in 5% acetic acid. Thus, temperature and concentration of acetic acid was optimized to reduce time of recycling while still using low concentrations of acetic acid. There is increase in viscosity of solution at 25%, 50% and higher concentrations of acetic acid during recycling. In 10-15% acetic acid the solution of plastic does not get very high viscosity and may be re-used for subsequent recycling.

The epoxy industry has sustainability concerns, especially concerns on waste management of end-of-life epoxy composites. There is also significant value loss due to manufacturing waste, which is large and irrecoverable. The instant recycling process is an industrially feasible, scalable recycling and recovery process that addresses these afore concerns. While various acids may be used, using inexpensive weak acids such as acetic acid, lactic acid etc. for this purpose at high temperatures makes the process industrially relevant.

The present invention is an industrially viable recycling process for recyclable epoxy thermosets comprising cleavable linkages, said process using an acid solution to dissolve the epoxy thermoset and devolatizing the acid solution from a thermoplastic acidic mixture to produce the thermoplastic component. The process is environmentally and economically advantageous and permits efficient recovery of the thermoplastic component and optionally the reinforcement matrix component, both of which can be recycled for further use.

While the present invention has been described with respect to certain embodiments, it will be apparent to those skilled in the art that various changes and modifications may be made without departing from the scope of the invention as defined in the following claims.

1. A process for recycling an epoxy thermoset comprising at least one recyclable component, said process comprising:
i. dissolving the epoxy thermoset in an acid solution under heated conditions of 50 to 110° C. resulting in formation of a thermoplastic mixture;
ii. filtering the thermoplastic mixture to separate out a reinforcement matrix component from a thermoplastic solution; and
iii. devolatizing the thermoplastic solution to remove the acid solution to obtain a recyclable thermoplastic component.

2. The process as claimed in claim 1, wherein filtering comprises sorting of the components by centrifugation, manual sorting, optical sorting, or a combination thereof.

3. The process as claimed in claim 1, wherein the acid solution is acetic acid, lactic acid, propionic acid, any other aliphatic acid, any other organic acid, or a combination thereof, the acetic acid being in a concentration of 5 to 70% and lactic acid being in a concentration of 20 to 80%.

4. The process as claimed in claim 1, wherein the acid solution contains a solvent selected from water, butanol, isopropanol, propanol, ethanol, methanol, benzyl alcohol, ethylene glycol, dichloromethane, tetrahydrofuran, ethyl acetate, acetone, dimethylformamide, acetonitrile, dimethyl sulfoxide, nitromethane, propylene carbonate, pentane, hexane, cyclohexane, benzene, toluene, xylene, dioxanes, glyme, polyethers, diethylether, any other nonpolar solvent, any other polar aprotic solvent, any other polar protic solvent, and a combination thereof.

5. The process as claimed in claim 1, wherein the removed acid solution, the solvent, or both is recycled back in the process.

6. The process as claimed in claim 1, wherein the epoxy thermoset is prepared from:
a diepoxy resin and a recyclable acid labile curing agent, wherein the recyclable acid labile curing agent is an amine-based hardener, a thiol-based hardener, a poly amino compound, any other acid labile hardener, or a combination thereof; or
a recyclable epoxy resin and a curing agent, wherein the recyclable epoxy resin comprises an acid degradable acetal, ketal, orthocarbonate, orthoester, orthosilicate or silane linkage.

7. The process as claimed in claim 1, wherein the reinforcement matrix component comprises glass fiber, carbon fiber, aramid fiber, jute, grass, bamboo, pine, balsa, any other natural fiber, and a combination thereof and is recyclable.

8. A recyclable thermoplastic component obtained using the process as claimed in claim 1.

9. (canceled)

10. (canceled)

11. (canceled)

12. A process for recycling an epoxy thermoset comprising a recyclable component, said process comprising:
i. dissolving the epoxy thermoset in an acid solution resulting in at least partial dissolution of the epoxy thermoset to form a thermoplastic mixture; and
ii. devolatizing the thermoplastic mixture to remove the acid solution to obtain a recyclable thermoplastic component comprising a reinforcement matrix component.

13. The process as claimed in claim 12, wherein the epoxy thermoset is reduced in size prior to dissolving in the acid solution.

14. The process as claimed in claim 12, wherein soaking of the epoxy thermoset in the acid solution is performed in heated conditions from 50° C. to 110° C.

15. The process as claimed in claim 12, wherein the acid solution is acetic acid, lactic acid, propionic acid, any other aliphatic acid, any other organic acid, sulfuric acid, phosphoric acid, any other inorganic acid, or a combination thereof, the acetic acid being in a concentration of 5 to 70%, lactic acid being in a concentration of 20 to 80%, sulfuric acid being in a concentration of 1 to 10%, phosphoric acid being in a concentration of 20 to 90%.

16. The process as claimed in claim 12, wherein the acid solution contains a solvent selected from water, butanol, isopropanol, propanol, ethanol, methanol, benzyl alcohol, ethylene glycol, dichloromethane, tetrahydrofuran, ethyl acetate, acetone, dimethylformamide, acetonitrile, dimethyl sulfoxide, nitromethane, propylene carbonate, pentane, hexane, cyclohexane, benzene, toluene, xylene, dioxanes, glyme, polyethers, diethylether, any other nonpolar solvent, any other polar aprotic solvent, any other polar protic solvent, and a combination thereof.

17. The process as claimed in claim 12, wherein the removed acid solution, the solvent, or both is recycled back in the process.

18. The process as claimed in claim 12, wherein the epoxy thermoset is prepared from:
a diepoxy resin and a recyclable acid labile curing agent, wherein the recyclable acid labile curing agent is an amine-based hardener, a thiol-based hardener, a poly amino compound, any other acid labile hardener, or a combination thereof; or
a recyclable epoxy resin and a curing agent, wherein the recyclable epoxy resin comprises an acid degradable acetal, ketal, orthocarbonate, orthoester, orthosilicate or silane linkage.

19. A recyclable thermoplastic component obtained using the process as claimed in claim 12.

20. (canceled)

21. (canceled)

22. (canceled)
